(19) United States
(12) Patent Application Publication
(10) Pub. No.: US 2008/0141537 A1
(43) Pub. Date: Jun. 19, 2008

(54) Net-Reciprocating Type Electric Razor

(76) Inventor: Tae-Jun Oh, Gyeonggi-do (KR)

Correspondence Address: CANTOR COLBURN, LLP, 20 Church Street, 22nd Floor, Hartford, CT, 06103, US

(21) Appl. No.: 11/813,520

(22) PCT Filed: Dec. 13, 2005
(86) PCT No.: PCT/KR05/04260

§ 371 Date: Jul. 9, 2007

(30) Foreign Application Priority Data
Jan. 12, 2005 (KR) 2020050000975

(51) Int. Cl. B26B 19/02

(52) U.S. Cl. 30/42

(57) ABSTRACT

Disclosed is a net-reciprocating type electric razor having a head part and a body. The head part includes a main gear and auxiliary gears, a speed reduction gear having an auxiliary speed reduction gear, a first vibrator mounted on the auxiliary speed reduction gear, a first driven gear engaged with the auxiliary speed reduction gear, a second driven gear engaged with an auxiliary gear of the first driven gear, a second vibrator coupled to the second driven gear, and a reciprocating blade. The head part further includes a rotary frame and a stationary frame. The rotary frame includes the iron net, rotating pins to be inserted into holes of a cover, and a first coupler for the coupling of a vibrating shaft. The stationary frame includes protrusions for the coupling of the reciprocating blade, and a second coupler for the coupling of an eccentric shaft of the first vibrator.

### TECHNICAL FIELD

The present invention relates to a net-reciprocating type electric razor including a net, which can be reciprocated back and forth, and more particularly, to a net-reciprocating type electric razor wherein an iron net of a head part is angularly moved when one or more cutting blades are reciprocated from side to side, whereby a smooth shaving operation can be accomplished, and hair of a specific facial region, for example, beneath the jaw, which is difficult to shave with conventional razors, can be efficiently shaved with an increased cutting force.

### BACKGROUND ART

There have been proposed a large number of electric reciprocating type razors, each of which includes a plurality of cutting blade heads movable freely relative to a body part, such that the plural cutting blade heads are brought into tight contact with the skin of a user, whereby a rapid and efficient shaving operation is accomplished.

One example of the conventional electric reciprocating type razors is disclosed in Japanese Unexamined Patent Publication No. S62-227395, wherein a rotary shaft is mounted in the vicinity of the upper end of a head block including a plurality of cutting blade heads, such that the head block can be angularly moved back and forth about the rotary shaft, whereby the cutting blade heads follow the skin of a user in every shaving direction. In the disclosed electric reciprocating type razor, however, the rotary shaft is disposed in the vicinity of the upper end of the head block, and therefore, the distance between the external blades, which are brought into contact with the skin, and the rotary shaft is small. As a result, if a pressing force is small when the external cutting blades are brought into contact with the skin while being inclined to the skin, the angular movement of the head block is difficult. Furthermore, it is not possible to suspend the head block, i.e., it is not possible to push upward the head block such that the head block can be freely moved, and therefore, the head block can follow the contour of the skin only from side to side, and the head block cannot absorb impacts generated due to uneven bone parts when the shaving operation is performed. Consequently, the skin may be damaged, or smooth shaving operation may not be accomplished.

Another example of the conventional electric reciprocating type razors is disclosed in Japanese Unexamined Patent Publication No. S55-86490, wherein a plurality of cutting blade heads are independently suspended by means of springs, such that the cutting blade heads can be freely moved upward and downward, whereby the cutting blade heads follow the uneven skin through the vertical movement of the respective cutting blade heads while absorbing impacts due to the unevenness of the skin. In the disclosed electric reciprocating type razor, however, it is required to set an initial load to the suspension force (the force by which the cutting blade heads are pushed upward by the respective springs) to more than a predetermined value in order to control the vibration of the entirety of the cutting blade heads due to the operation of the internal cutting blades. Consequently, if the pressing force, which is applied to the skin, is not considerably large, the cutting blade heads cannot properly follow the skin. Furthermore, when the external cutting blades are brought into contact with the skin while being inclined to the skin, the cutting blade heads cannot be brought into contact with the skin while the cutting blade heads are at a right angle to the skin. Consequently, the performance of the electric reciprocating type razor is not sufficiently accomplished.

Another example of the conventional electric reciprocating type razors is disclosed in Japanese Unexamined Patent Publication No. S63-197484, wherein a plurality of cutting blade heads are constructed to be freely moved, and adjacent cutting blade heads are coupled with each other by a ring, such that one of the coupled cutting blade heads is moved upward when the other of the coupled cutting blade heads is moved downward, whereby the cutting blade heads follow the unevenness of the skin. In the disclosed electric reciprocating type razor, however, it is not possible to absorb impacts generated when a shaving operation is performed. Furthermore, the cutting blade heads are not brought into contact with the skin while the cutting blade heads are at a right angle to the skin. Consequently, the performance of the electric reciprocating type razor is not sufficiently accomplished.

Still another example of the conventional electric reciprocating type razors is disclosed in Japanese Unexamined Patent Publication No. H10-43443, wherein cutting blade heads are integrally attached to a motor such that the cutting blade heads can be moved back and forth, from side to side, and upward and downward. In the disclosed electric reciprocating type razor, however, the supporting points provided to move the cutting blade heads are considerably low, and therefore, satisfactory following of the cutting blade heads to the skin is not accomplished

### DISCLOSURE OF INVENTION

### Technical Problem

Therefore, the present invention has been made in view of the above problems, and it is an object of the present invention to provide a net-reciprocating type electric razor which has a relatively simple structure and which can be brought into wide and smooth contact with the skin of a user, whereby a specific facial area, which is difficult to shave with conventional razors, can be efficiently shaved

### Technical Solution

In accordance with the present invention, the above and other objects can be accomplished by the provision of a net-reciprocating type electric razor comprising: a head part and a body part, the head part comprising: a main gear fitted to a drive shaft of a drive motor; a pair of auxiliary gears engaged with the main gear; a speed reduction gear having an auxiliary speed reduction gear provided at the top thereof, the main and auxiliary gears being seated to the speed reduction gear; a first vibrator mounted on the top of the auxiliary speed reduction gear; a first driven gear engaged with the auxiliary speed reduction gear at a circumferential side location of the auxiliary speed reduction gear, and having an auxiliary gear provided at the top thereof; a second driven gear engaged with the auxiliary gear of the first driven gear; a second vibrator coupled to the second driven gear; and a reciprocating blade, wherein the head part further comprises a rotary frame and a stationary frame, wherein the rotary frame includes: an iron net fitted to the top thereof; a pair of rotating pins formed at opposite side surfaces thereof, respectively, to be inserted into a pair of holes of an outer cover; and a first coupler formed at a side location of the bottom thereof for the coupling of a vibrating shaft that protrudes from one end of a vibrating plate, an eccentric shaft of the second vibrator being coupled to the other end of the vibrating plate, and wherein the stationary frame includes: a plurality of protrusions provided at opposite front and rear surfaces thereof for the coupling of the reciprocating blade; and a first coupler provided at the center of the bottom thereof for the coupling of an eccentric shaft of the first vibrator.

### ADVANTAGEOUS EFFECTS

As stated above, the net-reciprocating type electric razor according to the present invention is configured such that a rotary frame of a head part, which is provided with an iron net, is angularly moved when one or more cutting blades are reciprocated from side to side, whereby a smooth shaving operation can be accomplished, and hair of a specific facial area, for example, beneath the jaw, which is difficult to shave with conventional razors, can be efficiently shaved with an increased cutting force. Consequently, the net-reciprocating type electric razor of the present invention can be brought into smooth contact with the skin of a user when a shaving operation is performed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view, partially in enlarged scale, illustrating a net-reciprocating type electric razor according to the present invention;

FIG. 2 is a perspective view illustrating the structure of a heat part according to the present invention;

FIG. 3 is a schematic side view illustrating the reciprocating motion of a net provided in the net-reciprocating type electric razor according to the present invention;

FIG. 4 is a front view illustrating the structure of the head part of the net-reciprocating type electric razor according to the present invention; and

FIG. 5 is an exploded perspective view illustrating constituent elements of the head part of the net-reciprocating type electric razor according to the present invention.

### MODE FOR THE INVENTION

Now, a preferred embodiment of the present invention will be described in detail with reference to the accompanying drawings.

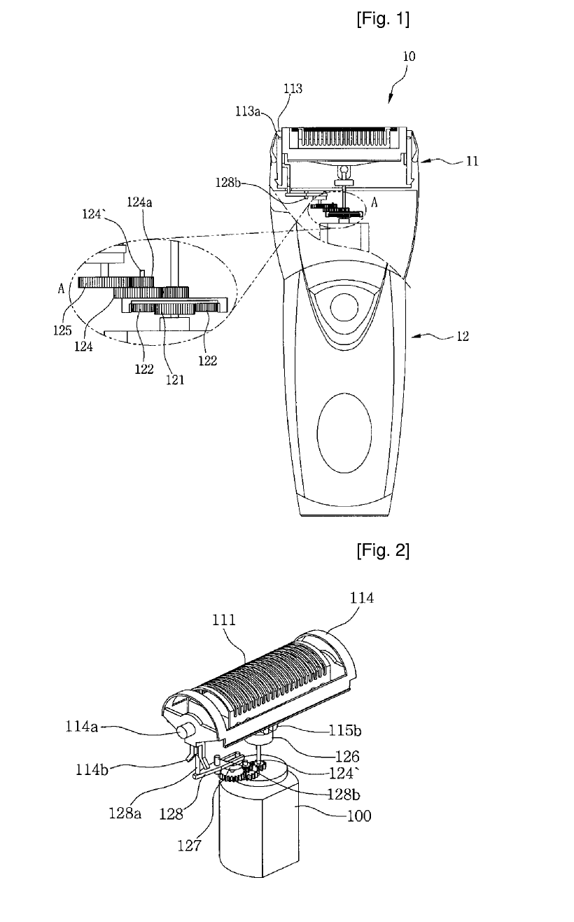

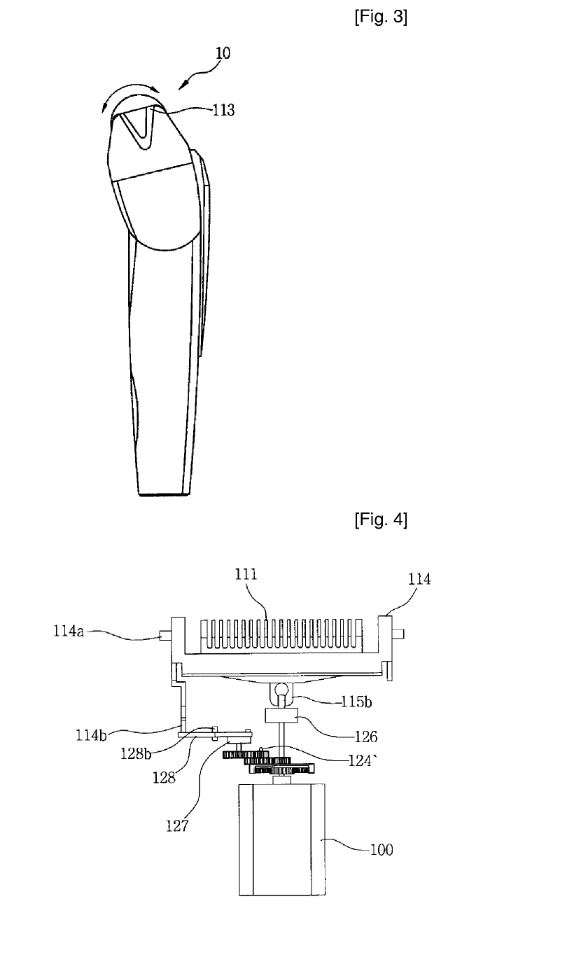

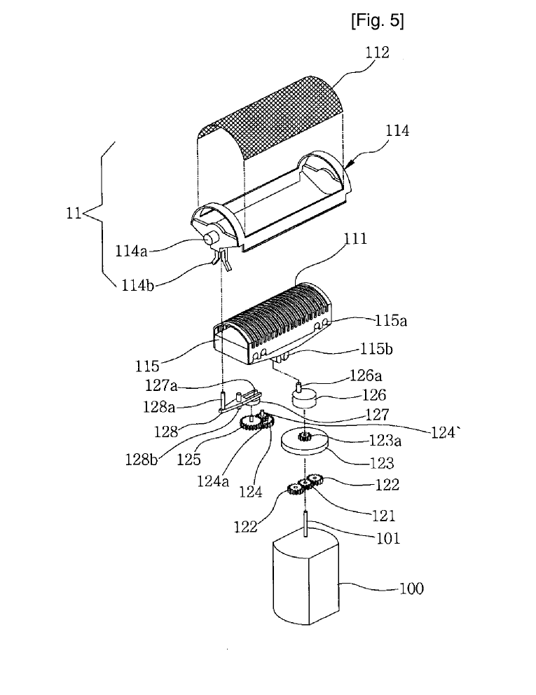

FIG. 1 is a front view, partially in enlarged scale, illustrating a net-reciprocating type electric razor according to the present invention. FIG. 2 is a perspective view illustrating the structure of a heat part according to the present invention. FIG. 3 is a schematic side view illustrating the reciprocating motion of a net provided in the net-reciprocating type electric razor according to the present invention. FIG. 4 is a front view illustrating the structure of the head part of the net-reciprocating type electric razor according to the present invention. FIG. 5 is an exploded perspective view illustrating constituent elements of the head part of the net-reciprocating type electric razor according to the present invention.

The net-reciprocating type electric razor according to the present invention, which is designated as reference numeral 10, has a configuration wherein a rotary frame 114 of a head part 11, which is provided with an iron net 12, is angularly moved when a reciprocating blade 111, which is located inside the iron net 112 while being coupled to a stationary frame 115, is reciprocated from side to side, whereby a smooth shaving operation can be accomplished.

Now, the interior configuration of the net-reciprocating type electric razor according to the present invention will be explained in more detail with reference to FIGS. 1 and 2, and more particularly, with reference to FIG. 5 illustrating the constituent elements of the net-reciprocating type electric razor.

The net-reciprocating type electric razor of the present invention is divided into the head part 11, and a body part 12. The head part 11 basically comprises: a main gear 121 fitted to a drive shaft 101 of a drive motor 100; a pair of auxiliary gears 122 engaged with the main gear 121; a speed reduction gear 123 having an auxiliary speed reduction gear 123a provided at the top thereof, the main and auxiliary gears 121 and 122 being seated to the speed reduction gear 123; a first vibrator 126 mounted on the top of the auxiliary speed reduction gear 123a; a first driven gear 124 engaged with the auxiliary speed reduction gear 123a at a circumferential side location of the gear 123a, and having an auxiliary gear 124a provided at the top thereof; a second driven gear 125 engaged with the auxiliary gear 124a; a second vibrator 127 coupled to the second driven gear 125; and the reciprocating blade 111.

The net-reciprocating type electric razor of the present invention is characterized in that the rotary frame 114 of the head part 11 includes: the iron net 112 fitted to the top thereof; a pair of rotating pins 114a formed at opposite side surfaces thereof, respectively, to be inserted into a pair of holes 113a of an outer cover 113; and a first coupler 114b formed at a side location of the bottom thereof for the coupling of a vibrating shaft 128a that protrudes from one end of a vibrating plate 128, an eccentric shaft 127a of the second vibrator 127 being coupled to the other end of the vibrating plate 128.

The net-reciprocating type electric razor of the present invention is also characterized in that the stationary frame 115 of the head part 11 includes: a plurality of protrusions 115a provided at opposite front and rear surfaces thereof for the coupling of the reciprocating blade 111; and a second coupler 115b provided at the center of the bottom thereof for the coupling of an eccentric shaft 126a of the first vibrator 126.

With the above-described configuration, the rotary frame 114, mounted with the iron net 112, is angularly moved when the reciprocating blade 111 is reciprocated from side to side, whereby hair of a specific facial area, for example, beneath the jaw, which is difficult to shave, can be smoothly shaved with an increased cutting force.

### INDUSTRIAL APPLICABILITY

As apparent from the above description, the net-reciprocating type electric razor according to the present invention is configured such that a rotary frame of a head part, which is provided with an iron net, is angularly moved when one or more cutting blades are reciprocated from side to side, whereby a smooth shaving operation can be accomplished, and hair of a specific facial area, for example, beneath the jaw, which is difficult to shave with conventional razors, can be efficiently shaved with an increased cutting force. Consequently, the net-reciprocating type electric razor of the present invention can be brought into smooth contact with the skin of a user when a shaving operation is performed.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

1. A net-reciprocating type electric razor comprising: a head part and a body part, the head part comprising: a main gear fitted to a drive shaft of a drive motor; a pair of auxiliary gears engaged with the main gear; a speed reduction gear having an auxiliary speed reduction gear provided at the top thereof, the main and auxiliary gears being seated to the speed reduction gear; a first vibrator mounted on the top of the auxiliary speed reduction gear; a first driven gear engaged with the auxiliary speed reduction gear at a circumferential side location of the auxiliary speed reduction gear, and having an auxiliary gear provided at the top thereof; a second driven gear engaged with the auxiliary gear of the first driven gear; a second vibrator coupled to the second driven gear; and a reciprocating blade,
wherein the head part further comprises a rotary frame and a stationary frame, wherein the rotary frame includes: an iron net fitted to the top thereof; a pair of rotating pins formed at opposite side surfaces thereof, respectively, to be inserted into a pair of holes of an outer cover; and a first coupler formed at a side location of the bottom thereof for the coupling of a vibrating shaft that protrudes from one end of a vibrating plate, an eccentric shaft of the second vibrator being coupled to the other end of the vibrating plate, and
wherein the stationary frame includes: a plurality of protrusions provided at opposite front and rear surfaces thereof for the coupling of the reciprocating blade; and a second coupler provided at the center of the bottom thereof for the coupling of an eccentric shaft of the first vibrator.
